(19) United States
(12) Patent Application Publication
(10) Pub. No.: US 2009/0012824 A1
(43) Pub. Date: Jan. 8, 2009

(54) APPARATUS AND METHOD FOR SUPPLYING AN AGGREGATED AND ENHANCED ITINERARY

(76) Inventors: Gregg BROCKWAY, San Francisco, CA (US); Scott HINTZ, San Francisco, CA (US); Andrew DENMARK, San Francisco, CA (US)

Correspondence Address: COOLEY GODWARD KRONISH LLP;ATTN: Patent Group, Suite 1100, 777 - 6th Street, NW, Washington, DC, 20001, US

(21) Appl. No.: 11/774,489

(22) Filed: Jul. 6, 2007

(51) Int. Cl. G06Q 10/00

(52) U.S. Cl. 705/6

(57) ABSTRACT

A computer readable storage medium supplies an aggregated and enhanced itinerary. The computer readable storage medium includes instructions to select an itinerary template based upon disparate itinerary booking events created for a user. The computer readable storage medium further includes instructions to evaluate the itinerary messages and identify logical relationships between travel events. The computer readable storage medium further includes instructions to produce enhanced travel information based on logical relationships identified within the itinerary messages. The computer readable storage medium further includes instructions to populate an itinerary with information from the received itinerary messages and enhanced travel information. Finally, the computer readable storage further includes instructions to deliver the itinerary to a user.

### BRIEF DESCRIPTION OF THE INVENTION

The present invention relates generally to coordinating travel plans in a networked environment. More particularly, this invention is directed at supplying an aggregated and enhanced itinerary.

### BACKGROUND OF THE INVENTION

The Internet has helped revolutionize consumer browsing and booking of travel services. In particular, travel services such as hotel, flight, cruise, and restaurant reservations are available for the average consumer to shop, compare and book online. Booking sites such as Travelocity, Expedia, and Orbitz, travel agents and Global Distribution Systems (GDS) provide a wide variety of inventory selections from different airlines, hotels and rental car companies. An itinerary is usually provided for the services booked through such a site.

Most large travel suppliers, such as United Airlines and Hilton Hotels also offer their own travel sites where consumers buy directly from the company, which generates and supplies itineraries related to the travel services booked through the company. Thus, for any given trip an individual may receive multiple itineraries from multiple entities. It would be desirable to provide a technique to aggregate and enhance multiple itineraries received from multiple entities.

### SUMMARY OF THE INVENTION

A computer readable storage medium supplies an aggregated and enhanced itinerary. The computer readable storage medium includes instructions to select an itinerary template based upon disparate itinerary booking events created for a user. The computer readable storage medium further includes instructions to evaluate the itinerary messages and identify logical relationships between travel events. The computer readable storage medium further includes instructions to produce enhanced travel information based on logical relationships identified within the itinerary messages. The computer readable storage medium further includes instructions to populate an itinerary with information from the received itinerary messages and enhanced travel information. Finally, the computer readable storage medium includes instructions to deliver the itinerary to a user.

### BRIEF DESCRIPTION OF THE FIGURES

The invention is more fully appreciated in connection with the following detailed description taken in conjunction with the accompanying drawings, in which:

FIG. 1 illustrates a computer configured to supply an enhanced and aggregated itinerary template, in accordance with one embodiment of the present invention.

FIG. 2 illustrates processing operations associated with creating an aggregate itinerary template, in accordance with one embodiment of the present invention.

FIG. 3 illustrates processing operations associated with selecting an appropriate template associated with received user input, in accordance with one embodiment of the present invention.

FIG. 4 illustrates processing operations associated with parsing data and identifying logical relationships of travel information, in accordance with one embodiment of the present invention.

FIG. 5 illustrates processing operations associated with enhancing information for a travel itinerary, in accordance with one embodiment of the present invention.

FIG. 6 illustrates processing operations associated with populating an itinerary template, in accordance with one embodiment of the present invention.

FIG. 7 illustrates processing operations associated with delivering a populated itinerary template to a user or a list of users, in accordance with one embodiment of the present invention.

FIG. 8 illustrates a network configured in accordance with an embodiment of the invention.

FIG. 9A illustrates a portion of an itinerary constructed in accordance with one embodiment of the present invention.

FIG. 9B illustrates a portion of an itinerary constructed in accordance with one embodiment of the present invention.

Like reference numerals refer to corresponding parts throughout the several views of the drawings.

### DETAILED DESCRIPTION OF THE INVENTION

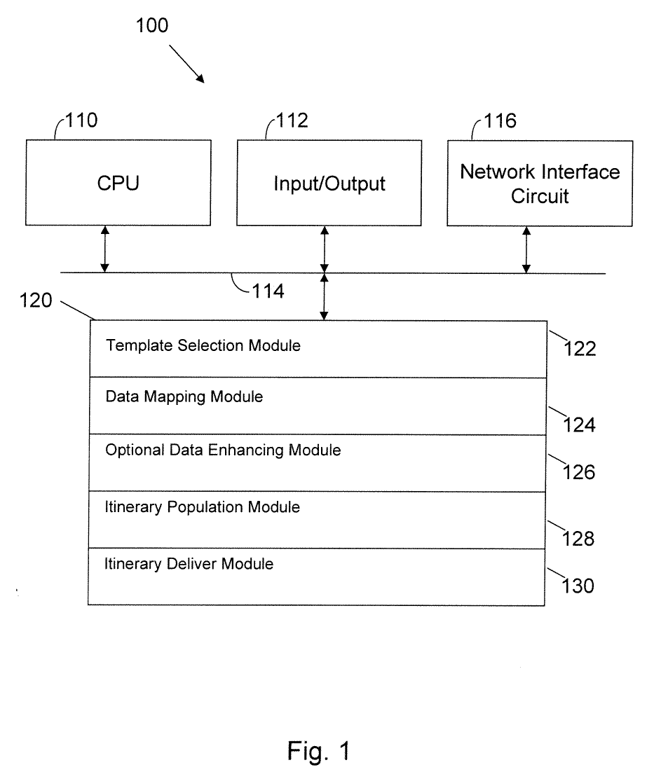

FIG. 1 illustrates a computer system 100 configured in accordance with an embodiment of the invention. The computer system 100 includes standard components, such as central processing unit 110, which communicates with a set of input/output devices 112 over a bus 114. The input/output devices 112 may include a keyboard, mouse, monitor, printer, and the like. Also connected to bus 114 is Network Interface Card (NIC) 116, which facilitates network communications using standard techniques. A memory 120 is also connected to bus 114. The memory 120 includes executable instructions to implement operations associated with the invention.

The memory 120 stores a template selection module 122 to select a template associated with a received itinerary message. The memory 120 also stores a data mapping module 124 to identify logical relationships in a template and parse received information. The memory 120 also stores an optional data enhancing module 126 to generate itinerary information, such as time and location specific enhancing information. The memory 120 also stores itinerary population module 128 to populate an aggregate itinerary template with received itinerary message and enhancing information. The memory 120 also stores delivery module 130 to deliver the itinerary to a user or a list of users.

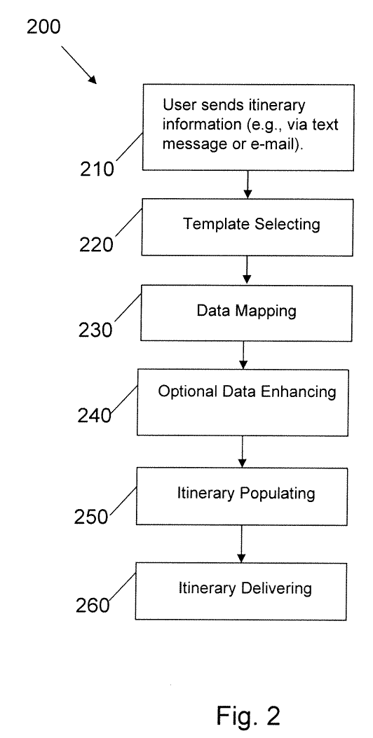

FIG. 2 illustrates one embodiment of a method 200 for creating an aggregated and enhanced itinerary. Operation 210 receives itinerary information (e.g., travel information) from a user. Operation 220 selects a template based on received itinerary information. In one embodiment, operation 220 preprocesses received itinerary information and selects a template based on the itinerary information. In another embodiment, operation 220 populates multiple templates and selects the template with the highest score. Operation 230 identifies logical relationships and extracts itinerary information. In one embodiment, operation 230 identifies logical relationships between travel events (e.g., travel time, start and end locations) and parses the itinerary information. Operation 240 performs optional data enhancing. In one embodiment, data enhancing entails augmenting itinerary information with missing itinerary data. In another embodiment, data enhancing entails adding to itinerary information enrichment data associated with itinerary time and location information. Operation 250 populates an itinerary with received itinerary information and enhancing information. Operation 260 provides the populated itinerary to a user or a list of users. In alternate embodiments, operation 260 provides alerts related to the populated itinerary, or inserts the populated itinerary in a calendar system. Operations 220, 230, 240, 250 and 260 may be respectively implemented with modules 122, 124, 126, 128 and 130.

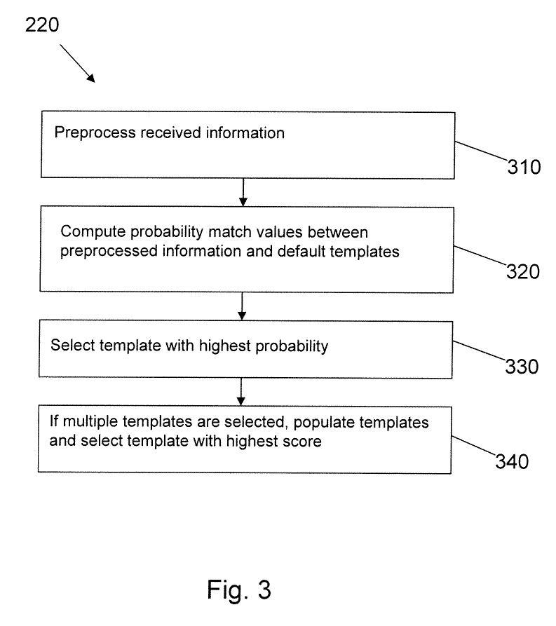

FIG. 3 illustrates one implementation of the template selection operation 220. Operation 310 receives and preprocesses itinerary information. In one embodiment, the itinerary information is associated with a variety of itinerary information (e.g., flight, rental car, hotel, cruise, restaurant). In another embodiment, the travel information is received via a variety of electronic communication methods (e.g., e-mail, text message, web browser plug-in). The travel information may include details of an itinerary purchase, details of a travel booking, or other itinerary booking details. In one embodiment, operation 310 normalizes the preprocessed data to a universal format. The normalization results in a marked up document. For example, operation 310 may normalize the preprocessed information by removing semantically un-important transformations. In another embodiment, operation 310 loads an existing set of templates into a cache. Alternately, the templates may be loaded when the template selection module 122 is initially invoked. Each template contains one or more attribute keys. The attribute keys relate to travel characteristics (e.g., booking site, type of travel). Each of the attribute keys comprises a pattern and a weight.

Operation 320 computes the probability of a match between the preprocessed data and default templates. In one embodiment, operation 320 compares the preprocessed data with an attribute key in each template. Operation 320 may compute the probability of a match for each template based on the attribute key and a preprocessed data comparison. The probability may be computed as a function of the number of attributes found in the template adjusted by the weight of each attribute found. In another embodiment, operation 320 evaluates the preprocessed data for metric objects. The metric objects consist of a description of how well the itinerary was preprocessed (e.g., minimal number of tokens should have been found, number of tokens actually found, type of itinerary, percentage confidence in choice). In the same embodiment, operation 320 establishes a range of values for the metric objects. Operation 320 may store computed probabilities in a matrix and compare the preprocessed data with templates using the range of values. If the preprocessed data and templates comparison produces values outside the established range, the template is marked for manual inspection to determine a probability template and data match score.

Operation 330 selects the template with the highest score. Operation 340 determines if multiple templates were selected. In one embodiment, operation 340 populates the multiple templates. In the same embodiment, operation 340 computes the probability of matching at least a portion of the preprocessed data to each template. Operation 340 then selects the itinerary template with the highest score.

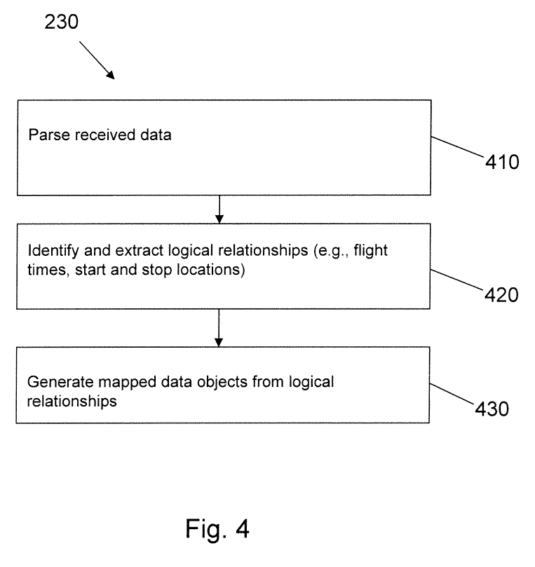

FIG. 4 illustrates one implementation of the data mapping operation 230. Operation 410 parses the data preprocessed at operation 310. In one embodiment, operation 410 parses the data using the highest scoring template in operation 330 or operation 340. In another embodiment, operation 410 parses the data based on field delimiters (e.g., keywords, spacing, formatting) of the selected template. In one embodiment, the resulting parsed information is flight information (e.g., departure data, departure city, airline, flight number, departure time, arrival time, number of stops, class of service), hotel information (e.g., hotel name, hotel location, star rating, average daily rate), and other travel information.

Operation 420 identifies and extracts logical relationships from the information parsed at operation 410. In one embodiment, the logical relationships relate to typed objects corresponding to received itinerary information. Logical relationships may relate to travel times, start and stop locations, user information, and location information. The logical relationships may be formed hierarchically, each sub hierarchical relationship corresponding to a certain portion of itinerary information and nested within the hierarchical relationship. In another embodiment, operation 420 may recognize there are no corresponding relationships associated with the user data.

Operation 430 generates mapped data objects associated with text parsed at operation 410 and logical relationships identified at operation 420. In one embodiment, the mapped data objects are a hierarchical structure of typed objects that represent elements of an itinerary associated with the received itinerary information. The mapped data objects may be serialized to XML to create XML mapped data objects. In alternate embodiments, operation 430 checks the mapped data objects and generates an error if appropriate.

In another embodiment, one of the mapped data segments corresponding to flight reservation data is labeled AirSegment. In the same embodiment, the mapped data segment corresponding to the start airport location is AirSegment::orig_airport_code. Similarly, th mapped data segment corresponding to the start city is AirSegment::orig_city_name. The mapped data segment corresponding to the destination city may be AirSegment::dest_city_name. The mapped data segment corresponding to the departure time may be AirSegment::departure_time. In alternate embodiments. the AirSegment may have AirSegment segments nested within it.

In another embodiment, one of the mapped data segments corresponding to hotel reservation data is labeled HotelReservation. In the same embodiment, the mapped data segment corresponding to the check-in date is HotelReservation::check_in_date. The mapped data segment corresponding with the check-in time may be HotelReservation::check_in_time. Similarly, the mapped data segment corresponding to the check-out date may be HotelReservation::check_out_date.

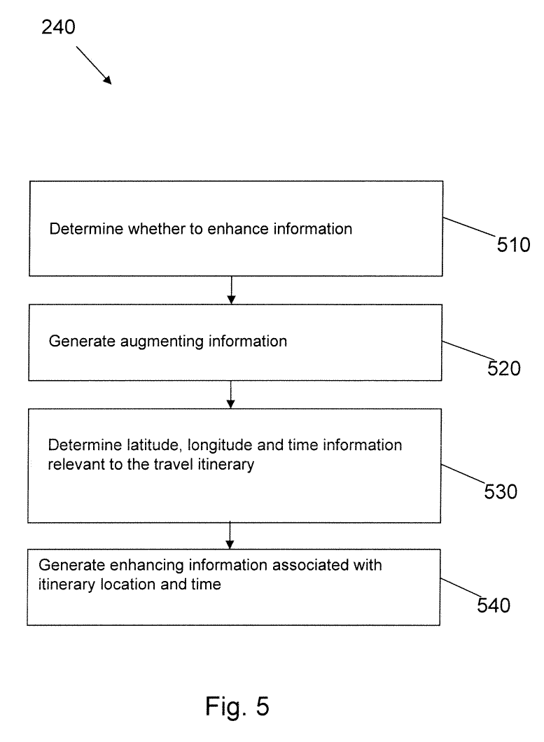

FIG. 5 illustrates one implementation of the data enhancing operation 240. Operation 510 determines whether to enhance the travel information with time and location specific information and additional data. In one embodiment, operation 510 compares the parsed data with default values in the selected template and then determines whether to enhance information. In another embodiment, operation 510 determines whether the mapped data objects generated at operation 430 and the logical relationships identified at operation 420 can generate further time and location specific information. In another embodiment, operation 510 refers to user preferences to determine whether to perform enhancing data operations.

Operation 520 generates augmenting information. In one embodiment, the augmenting information relates to travel information not found in parsed data. In the same embodiment, operation 520 generates augmenting information by comparing parsed data with the template selected at operation 330 or operation 340. In the same embodiment, the augmenting information is selected from flight code, flight length, hotel code, and airport information. In another embodiment, the augmenting information is retrieved from third party databases of travel information.

Operation 530 determines latitude, longitude and time information associated with the parsed itinerary information. In one embodiment, operation 530 refers to mapped data objects from operation 430 (e.g., AirSegment, HotelReservation) to determine latitude, longitude and time for specified events or locations. In another embodiment, latitude, longitude and time information is generated in real time. In another embodiment, the latitude, longitude, and time information is generated by referring to a variety of data sources outside system 100 (e.g., airport databases, OAG flight data bases. GeoNames database, Google Maps, Microsoft Virtual Earth). In the same embodiment, network interface 116 communicates with the outside data sources to retrieve latitude, longitude, and time information.

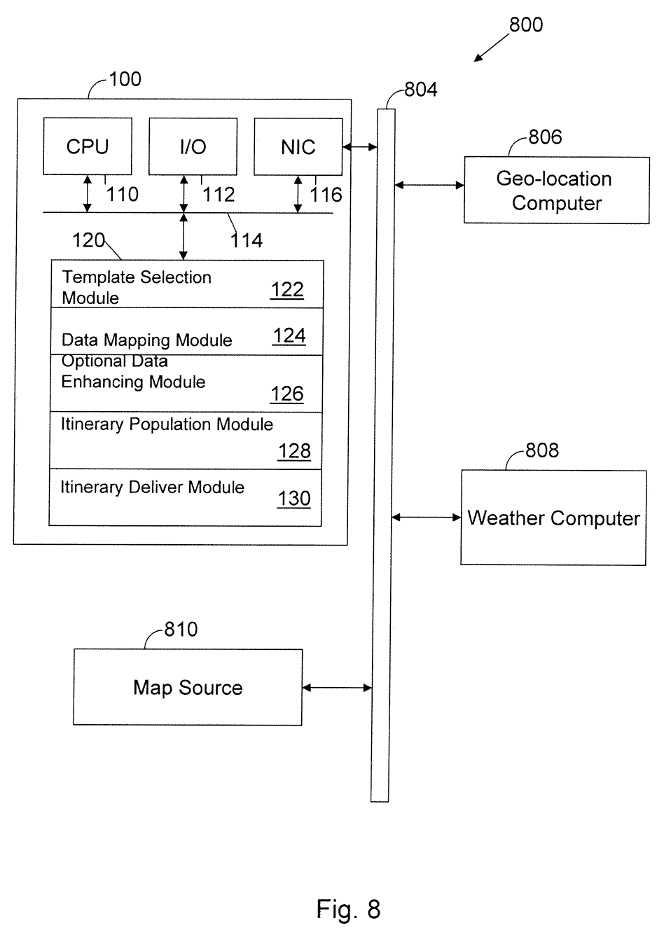

FIG. 8 illustrates one embodiment of network 800, which connects outside database entities with system 100. The network 800 includes system 100 connected to a communication path 804, which may be any wired path, wireless path, or combination wired and wireless path. The network 800 also includes geo-location computer 806. In one embodiment, computer 806 provides geo-location information relating to itinerary information. The network 800 also includes computer 808 and computer 810. Computer 808 provides weather information for the travel destination. Computer 810 is a map source database to provide maps and/or directions between destinations specified in the itinerary information.

Returning to FIG. 5, operation 540 generates enhancing information associated with the latitude, longitude, and time determined at operation 530. In one embodiment, enhancing information is selected from computer sources of maps, directions, weather, flight status, flight check-in, terminal maps, adjacent flight schedules, security updates, mobile access maps, budget planner, and other services related to location and time parameters. In alternate embodiments, enhancing information is generated based on user preferences and profile. In another embodiment, the enhancing information is generated by referring to a variety of data sources outside system 100 (e.g., airport databases, OAG flight data bases, GeoNames database, Google Maps, Microsoft Virtual Earth), as shown in FIG. 8. Network interface 116 may communicate with the outside data sources to retrieve latitude, longitude, and time information. Alternately, operation 540 generates enhancing information by referring to information in computer databases 808 and 810.

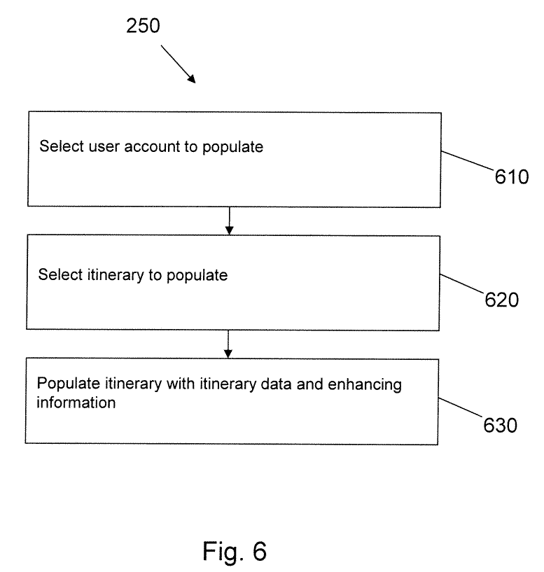

FIG. 6 illustrates one implementation of the itinerary populating operation 250. Operation 610 selects a user account. In one embodiment, operation 610 selects the user account or a list of user accounts associated with information received at operation 310. In the same embodiment, operation 610 selects the user account by examining the user email address from the information received at operation 310. Operation 610 may select the user account by examining the sender's address or other information received at 310. Operation 610 may determine that the user account exists in the user database. Alternatively, operation 610 may determine this is a new user account. In the same embodiment, operation 610 may create a new user account.

Operation 620 selects the itinerary to populate. In one embodiment, the itinerary is associated with the user account or the list of user accounts. Operation 620 may select an itinerary associated with the type of itinerary information received at operation 310. Operation 620 may select an existing itinerary. Alternatively, operation 620 may select a new itinerary. In the same embodiment, operation 620 creates a new itinerary to populate.

Operation 630 populates the itinerary with the itinerary information and enhancing information. In one embodiment, operation 630 populates the itinerary with itinerary information received at operation 310. In another embodiment, each mapped data object at operation 430 is populated into a corresponding itinerary document field. In another embodiment, operation 630 populates the itinerary document based on an existing organizational scheme. For example, operation 630 may populate the itinerary document based on an organizational scheme related to product type. In alternate embodiments, operation 630 populates the itinerary document in such a way as to create a logical display of integrated travel service information that expresses natural chronology or another natural order for user views.

Operation 630 also populates the itinerary document with enhancing information. In one embodiment, the enhancing information is augmenting information generated at operation 520. In another embodiment, the enhancing information is time and location specific enhancing information generated at operation 540. In another embodiment, operation 630 populates the itinerary document based on an existing organizational scheme. In other embodiments, operation 630 populates the itinerary and groups enhancing information for display on a map.

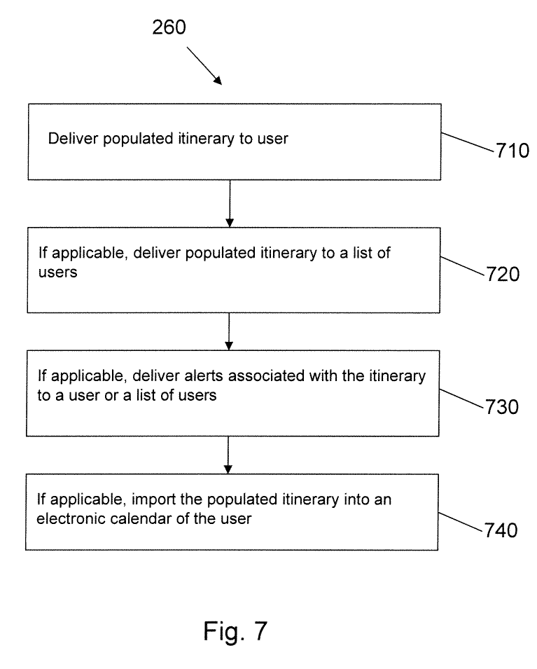

FIG. 7 illustrates one implementation of itinerary delivering operation 260. Operation 710 delivers the populated itinerary document to a user. In one embodiment, operation 710 delivers the populated itinerary electronically (e.g., text messaging, e-mail, web browser). Operation 720 delivers the populated itinerary document to a list of users. In one embodiment, operation 720 delivers the populated itinerary via electronic format (e.g., text messaging, e-mail, web browser). In another embodiment, the list of users is provided by a user. In another embodiment, operation 720 determines whether to deliver the populated itinerary to a list of users by referring to travel information received at operation 310. In another embodiment, operation 720 determines whether to deliver the populated itinerary to a list of users by referring to the populated itinerary document.

Operation 730 delivers alerts to notify a user or a list of users. In one embodiment, operation 730 may set up the alerts via an electronic system (e.g., e-mail, text message). In another embodiment, the alerts consist of partial itinerary information or a status message signaling an update. In another embodiment, operation 720 determines whether to deliver the alerts by referring to travel information received at operation 310. In another embodiment, operation 720 determines whether to deliver the alerts by referring to the populated itinerary document.

Operation 740 imports the populated itinerary document into an electronic calendar of the user. In one embodiment, operation 740 converts the itinerary into an export format (e.g., Vcard or Ical). In another embodiment, operation 720 determines whether to import the electronic calendar by referring to travel information received at operation 310. In another embodiment, operation 720 determines whether to import the electronic calendar by referring to the itinerary.

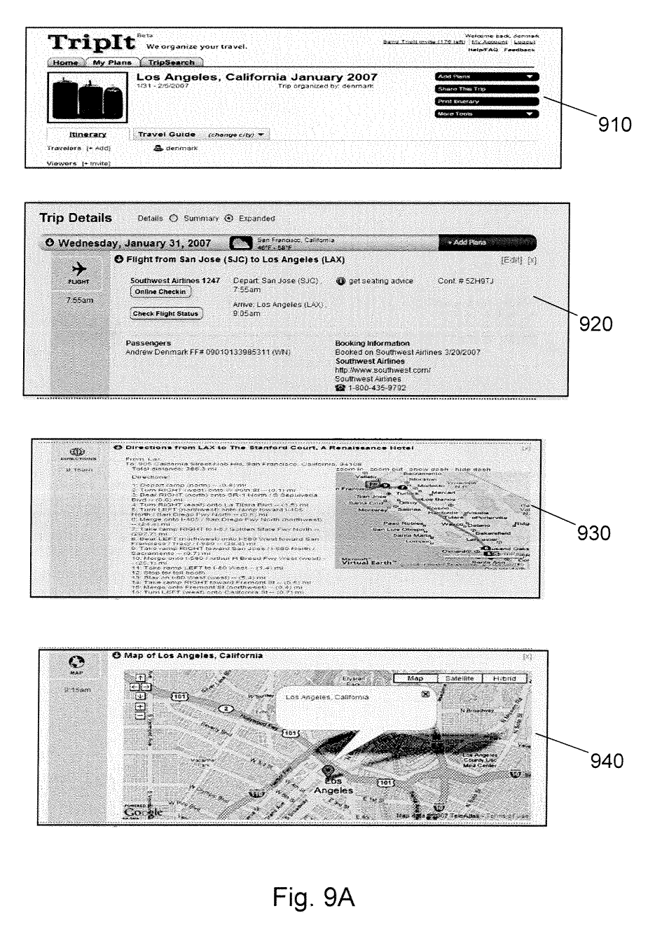

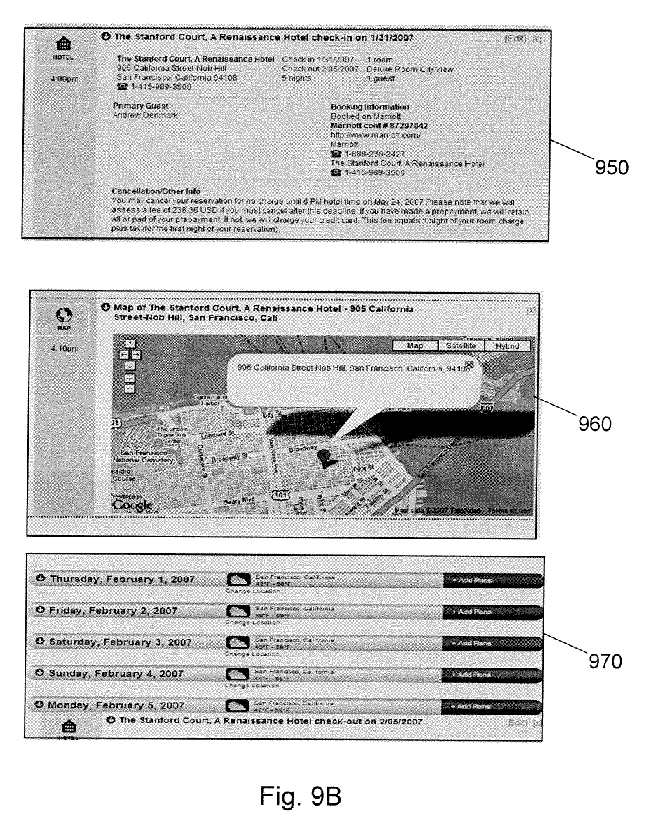

FIG. 9A illustrates one embodiment of an aggregated and enhanced itinerary. Itinerary section 910 includes interactive buttons to allow user input. Itinerary section 910 also includes user account information and the ability for the user to add additional itinerary travelers and additional itinerary viewers. Flight section 920 includes flight information. The flight information in section 920 is passenger information, booking information, airline information, flight times and/or airport locations. Direction section 930 includes directions from an arrival airport to a hotel. In one embodiment, the directions are generated in accordance with operation 540. In another embodiment, directions are acquired from a networked computer such as computer 808 shown in FIG. 8. Map section 940 includes a map related to the city of travel. In one embodiment, the map is acquired from networked computer 808 shown in FIG. 8. In another embodiment, the map is generated in accordance to operation 540.

FIG. 9B illustrates one embodiment of an aggregated and enhanced itinerary related to the itinerary in FIG. 9A. Lodging section 950 includes hotel itinerary information. Section 950 displays hotel location, guest information, booking information, confirmation number and checking-in, checking-out information. Lodging map section 960 includes a map related to the hotel location. The map may include local points of interest. The itinerary may be augmented to include additional information about local points of interest. In one embodiment, the map is acquired from networked computer 808 in FIG. 8. In another embodiment, the map is generated in accordance with operation 540. Weather section 970 includes weather information related to travel dates and locations. In one embodiment, the weather information is acquired from networked computer 810 shown in FIG. 8. In another embodiment, the map is generated in accordance to operation 540.

The invention has now been fully disclosed. Attention turns to specific examples and techniques for implementing operations associated with embodiments of the invention. consider an example in which operation 310 receives the following itinerary data.
From: tripituser@tripit.com
To: plans@tripit.com
Subject: Fw: E-Ticket Confirmation
Date: Tue, 19 Dec. 2006 09:41:54-0800
Confirmation Number
5ZH9TJ
Confirmation Date: Mar. 20, 2007
Received: ANDREW D
Passenger Information
Passenger Name
Ticket#
Account Number
DENMARK/ANDREW
356-2796353214-0
09010133985311
Itinerary:
Date
Flight
Routing Details
Wed January 31
1247
Depart SAN JOSE Calif. (SJC) at 7:55 AM
Arrive in LOS ANGELES INTL (LAX) at 9:05 AM
Cost and Payment Summary
Air $45.58
Tax $6.82
PFC Fee $4.50
Security Fee $2.50
Total Payment: $ $59.40
Prior payment(s)
03/20/2007 AMER EXPRESS xxxxxxxxxxx0101 Ref 592-2769522064-4 $59.40
Fare Rule(s)
Valid only on Southwest Airlines. NON REFUNDABLE/STANDBY REQ UPGRADE TO YL
All travel involving funds from this Confirm no. must be completed by 03/20/2008. Any change to this itinerary may result in a fare increase.
Fare Calculation:
NRF-1 SJCWNLAX M14NR 49.00 $49.00 ZP3.40 XFSJC4.50 AYSJC2.50 $59.40

The foregoing input is processed at operations 410, 420 and 430 to generate the following mapped data objects.

```
<Booking>
  <_sequence>0</_sequence>
  <email_from_address>tripituser@tripit.com</email_from_address>
  <email_to_address>plans@tripit.com</email_to_address>
  <email_subject>Fw: E-Ticket Confirmation</email_subject>
  <booking_uuid>312c7dcf-eb35-4c2e-ad8d-6c318da1ddcb
  </booking_uuid>
  <total_mdos>7</total_mdos>
  <total_missed_mdos>0</total_missed_mdos>
  <parse_pct>100</parse_pct>
  <total_tokens>17</total_tokens>
  <total_tokens_matched>17</total_tokens_matched>
  <AirReservation>
  <_sequence>0</_sequence>
  <booking_date>2007-03-20</booking_date>
  <booking_site_name>Southwest Airlines</booking_site_name>
  <booking_site_url>http://www.southwest.com/</booking_site_url>
  <booking_site_phone>1-800-435-9792</booking_site_phone>
  <AirFrequentFlyerNumber>
  <_sequence>0</_sequence>
  <air_traveler_id>DENMARK/ANDREW</air_traveler_id>
  <airline>WN</airline>
  <frequent_flyer_num>09010133985311</frequent_flyer_num>
  </AirFrequentFlyerNumber>
  <AirSupplierConfirmation>
  <_sequence>0</_sequence>
  <confirmation_num>5ZH9TJ</confirmation_num>
  </AirSupplierConfirmation>
  <AirTraveler>
  <_sequence>0</_sequence>
  <air_traveler_id>DENMARK/ANDREW</air_traveler_id>
  <f_name>ANDREW</f_name>
  <l_name>DENMARK</l_name>
  </AirTraveler>
  <AirETicketNumber>
  <_sequence>0</_sequence>
  <air_traveler_id>DENMARK/ANDREW</air_traveler_id>
  <eticket_num>356-2796353214-0</eticket_num>
  </AirETicketNumber>
```

The following code segment corresponds to itinerary section 920 as shown in FIG. 9A.

```
  <AirSegment>
    <_sequence>0</_sequence>
    <departure_date>2007-01-31</departure_date>
    <departure_time>07:55:00</departure_time>
    <orig_airport_code>SJC</orig_airport_code>
    <orig_city_name>SAN JOSE CA</orig_city_name>
    <dest_airport_code>LAX</dest_airport_code>
    <dest_city_name>LOS ANGELES INTL</dest_city_name>
    <arrival_time>09:05:00</arrival_time>
    <marketing_airline>WN</marketing_airline>
    <marketing_flight_number>1247</marketing_flight_number>
  </AirSegment>
  </AirReservation>
</Booking>
```

The following is a sample template that may be selected at operation 330.

############################################################
## Copyright 2007, TripIt, Inc.
##
## Subversion change information:
##
## $Id: AA_v1-f-html.map 1258 2007-04-23 17:40:41Z denmark $
## $HeadURL: https://svn/datamapper/trunk/src/etc/datamap/text/html/AA_v1-f-html.map $
## $LastChangedDate: 2007-04-23 10:40:41 -0700 (Mon, 23 Apr 2007) $
## $LastChangedRevision: 1258 $
## $LastChangedBy: denmark $
############################################################
#
## American Airlines HTML Flight confirmation
#
[_Default_]
root: Booking
content_type: text/html
attribute: (‘http://www.aa.com’, 100)
attribute: (‘E-Ticket\s+Confirmation’, 100)
attribute: (‘Confirmation\/Record\s+Locator’, 100)
attribute: (‘AA\.com’, 100)
attribute: (‘AMERICAN\s+AIRLINES’, 100)
[Booking]
property: (‘datamap_version’, ‘$Id: AA_v1-f-html.map 1258 2007-04-23 17:40:41Z denmark
$’)
property: (‘token’, ”)
formatter: (‘generate_token’, ‘token’, ”)
contains: AirReservation
[AirReservation]
contains: AirSupplierConfirmation
contains: AirETicketNumber
contains: AirTraveler
contains: AirFrequentFlyerNumber
contains: AirSegment
property: (‘booking_site_name’, ‘American Airlines’)
property: (‘booking_site_phone’, ‘1-800-433-7300’)
property: (‘booking_site_url’, ‘http://www.aa.com/’)
pattern: Date\s+of\s+Issue:\s+(?P<booking_date>\w+)
formatter: (‘format_date’, ‘booking_date’,
‘(?P<date>\d{1,2})(?P<month>\w+)(?P<year>\d\d)’)
[AirETicketNumber]
group_by: air_traveler_id
join_patterns: true
begin_zone: @field@(@cr@)?\s+PASSENGER@/field@
end_zone: @field@(@cr@)?\s+FARE-\w+@/field@
pattern: [\n\r]+@field@(@cr@)?\s+(?P<air_traveler_id>[A-Z]+\s+([A-Z]+\s+)??[A-
Z]+)@/field@
pattern: [\n\r]+@field@(@cr@)?\s+(?P<eticket_num>[\d]+[\d\-]*)@/field@
[AirSupplierConfirmation]
pattern: Record\s+Locator:\s+(?P<confirmation_num>\w+)
[AirTraveler]
group_by: air_traveler_id
join_patterns: true
begin_zone: @field@(@cr@)?\s+PASSENGER@/field@
end_zone: @field@(@cr@)?\s+TICKET\s+NUMBER@/field@
pattern: [\n\r]+@field@(@cr@)?\s+(?P<air_traveler_id>[A-Z]+\s+([A-Z]+\s+)??[A-
Z]+)@/field@
pattern: [\n\r]+@field@(@cr@)?\s+(?P<f_name>[A-Z]+)\s+(?P<m_name>[A-
Z]+\s+)??(?P<l_name>[A-Z]+)@/field@
[AirFrequentFlyerNumber]
group_by: air_traveler_id
pattern: [\n\r]+@field@(@cr@)?\s+(?P<air_traveler_id>[A-Z]+\s+([A-Z]+\s+)??[A-
Z]+)@/field@[\n\r]+@field@.*?@/field@[\n\r]+@field@.*?@/field@[\n\r]+@field@.*?@/
field@[\n\r]+@field@.*?@/field@[\n\r]+@field@(@cr@)?\s+FF#:\s+(?P<airline>[0-9A-
Z]{2})\s+(?P<frequent_flyer_num>\w+).*@/field@
[AirSegment]
contains: AirSeatAssignment
begin_zone: @field@(@cr@)?\s+Date:@/field@[\n\r]+@field@(@cr@)?\s+\d{1,2}[A-
Z]{1,3}\s+-\s+[A-Z]+@/field@
## AirSegment w/o an ‘Operated By:’
pattern:
@field@(@cr@)?\s+Date:@/field@[\n\r]+@field@(@cr@)?\s+(?P<departure_date>\d{1,2}
[A-Z]{1,3})\s+-\s+[A-
Z]+@/field@[\n\r]+@field@.*?@/field@[\n\r]+@field@.*?@/field@[\n\r]+@field@.*?@/field
@[\n\r]+@field@(@cr@)?\s+Flight\s+:@/field@[\n\r]+@field@(?P<marketing_airline>
.*?)@/field@[\n\r]+@field@(?P<marketing_flight_number>.*?)@/field@[\n\r]+@field@.*?
@/field@[\n\r]+@field@.*?@/field@[\n\r]+@field@(@cr@)?\s+Departure:@/field@[\n\r]+
@field@(@cr@)?(?P<orig_city_name>.*?)@/field@[\n\r]+@field@(@cr@)?\s+(?P<departure
_time>\d{1,2}:\d{2}\s+[AP]M@/field@[\n\r]+@field@.*?@/field@[\n\r]+@field@.*?
@/field@[\n\r]+@field@(@cr@)?\s+Arrival:@/field@[\n\r]+@field@(?P<dest_city_name>.
*?)@/field@[\n\r]+@field@(@cr@)?\s+(?P<arrival_time>\d{1,2}:\d{2}\s+[AP]M)@/field
@[\n\r]+@field@.*?@/field@[\n\r]+@field@.*?@/field@[\n\r]+@field@.*?@/field@[\n\r]
+@field@.*?@/field@[\n\r]+@field@.*?@/field@[\n\r]+@field@.*?@/field@[\n\r]+@field
@.*?@/field@[\n\r]+@field@(@cr@)?\s+(?P<service_class>.*?)@/field@[\n\r]+
## AirSegment w/ an ‘Operated By:’ w/ CHECK-IN
pattern:
@field@(@cr@)?\s+Date:@/field@[\n\r]+@field@(@cr@)?\s+(?P<departure_date>\d{1,2}
[A-Z]{1,3})\s+-\s+[A-
Z]+@/field@[\n\r]+@field@.*?@/field@[\n\r]+@field@.*?@/field@[\n\r]+@field@.*?@/field
@[\n\r]+@field@(@cr@)?\s+Flight\s+:@/field@[\n\r]+@field@(?P<marketing_airline>
.*?)@/field@[\n\r]+@field@(?P<marketing_flight_number>.*?)@/field@[\n\r]+@field@.*?
@/field@[\n\r]+@field@.*?@/field@[\n\r]+@field@(@cr@)?\s+Departure:@/field@[\n\r]+
@/field@(?P<orig_city_name>.*?)@/field@[\n\r]+@field@(@cr@)?\s+(?P<departure_time
>\d{1,2}:\d{2}\s+[AP]M)@/field@[\n\r]+@field@.*?@/field@[\n\r]+@field@.*?@/field@
[\n\r]+@field@(@cr@)?\s+Arrival:@/field@[\n\r]+@field@(?P<dest_city_name>.*?)@/field
@[\n\r]+@field@(@cr@)?\s+(?P<arrival_time>\d{1,2}:\d{2}\s+[AP]M)@/field@[\n\r]+@
field@.*?@/field@[\n\r]+@field@.*?@/field@[\n\r]+@field@(@cr@)?\s+Operated\s+By:
@/field@[\n\r]+@field@(@cr@)?\s*(OPERATED\s+BY\s+(?P<operating_airline>[A-
Z]+[\sA-Z]*?)\s+CHECK-
IN)?.*?@/field@[\n\r]+@field@.*?@/field@[\n\r]+@field@.*?@/field@[\n\r]+@field@.*?
@/field@[\n\r]+@field@.*?@/field@[\n\r]+@field@.*?@/field@[\n\r]+@field@(@cr@)?\s
+(?P<service_class>.*?)@/field@[\n\r]+
## AirSegment w an ‘Operated By:’ w/o CHECK-IN
pattern:
@field@(@cr@)?\s+Date:@/field@[\n\r]+@field@(@cr@)?\s+(?P<departure_date>\d{1,2}
[A-Z]{1,3})\s+-\s+[A-
Z]+@/field@[\n\r]+@field@.*?@/field@[\n\r]+@field@.*?@/field@[\n\r]+@field@.*?@/field
@[\n\r]+@field@(@cr@)?\s+Flight\s+:@/field@[\n\r]+@field@(?P<marketing_airline>
.*?)@/field@[\n\r]+@field@(?P<marketing_flight_number>.*?)@/field@[\n\r]+@field@.*?
@/field@[\n\r]+@field@.*?@/field@[\n\r]+@field@(@cr@)?\s+Departure:@/field@[\n\r]+
@field@(?P<orig_city_name>.*?)@/field@[\n\r]+@field@(@cr@)?\s+(?P<departure_time
>\d{1,2}:\d{2}\s+[AP]M)@/field@[\n\r]+@field@.*?@/field@[\n\r]+@field@.*?@/field@
[\n\r]+@field@(@cr@)?\s+Arrival:@/field@[\n\r]+@field@(?P<dest_city_name>.*?)@/field
@[\n\r]+@field@(@cr@)?\s+(?P<arrival_time>\d{1,2}:\d{2}\s+[AP]M)@/field@[\n\r]+@
field@.*?@/field@[\n\r]+@field@.*?@/field@[\n\r]+@field@(@cr@)?\s+Operated\s+By:
@/field@[\n\r]+@field@(@cr@)?\s*OPERATED\s+BY\s+(?P<operating_airline>[A-
Z]+[\/\sA-
Z]+)@field@@/field@[\n\r]+@field@.*?@/field@[\n\r]+@field@.*?@/field@[\n\r]+@field
@.*?@/field@[\n\r]+@field@.*?@/field@[\n\r]+@field@.*?@/field@[\n\r]+@field@(@cr
@)?\s+(?P<service_class>.*?)@/field@[\n\r]+
pattern: @field@.+?SEAT.+?@/field@[\n\r]+@field@(?P<service_class>.+?)@/field@
formatter: (‘format_date’, ‘departure_date’, ‘(?P<date>\d{1,2})(?P<month>\w+)’)
formatter: (‘format_time’, ‘departure_time’,
‘(?P<hour>\d{1,2}):(?P<minute>\d{1,2})\s+(?P<ampm>[AP]M)’)
formatter: (‘format_time’, ‘arrival_time’,
‘(?P<hour>\d{1,2}):(?P<minute>\d{1,2})\s+(?P<ampm>[AP]M)’)
[AirSeatAssignment]
group_by: air_traveler_id
pattern:
@field@(?P<air_traveler_id>.*?)@/field@[\n\r]+@field@.*?@/field@[\n\r]+@field@.*?@
/field@[\n\r]+@field@(@cr@)?\s+SEAT\s+(?P<seat>\d+[A-Z])@/field@

### [Booking]

In one embodiment the following itinerary mapped object may be generated at operation 430.

```
<AirSegment>
  <_sequence>0</_sequence>
  <departure_date>2007-01-31</departure_date>
  <departure_time>07:55:00</departure_time>
  <orig_airport_code>SJC</orig_airport_code>
  <orig_city_name>SAN JOSE CA</orig_city_name>
  <dest_airport_code>LAX</dest_airport_code>
  <dest_city_name>LOS ANGELES INTL</dest_city_name>
  <arrival_time>09:05:00</arrival_time>
  <marketing_airline>WN</marketing_airline>
  <marketing_flight_number>1247</marketing_flight_number>
</AirSegment>
```

The foregoing itinerary mapped object may be processed by operation 630 to create the following populated itinerary object. In particular, the mapped object is converted into a table in a database.

```
CREATE TABLE ‘air_trip_item‘
(
    ‘trip_item_id‘ INTEGER NOT NULL,
    ‘leg‘ INTEGER NOT NULL,
    ‘marketing_airline‘ VARCHAR(25),
    ‘marketing_airline_code‘ CHAR(2),
    ‘marketing_flight_num‘ VARCHAR(10),
    ‘operating_airline‘ VARCHAR(25),
    ‘operating_airline_code‘ CHAR(2),
    ‘operating_flight_num‘ VARCHAR(10),
    ‘orig_airport‘ VARCHAR(50),
    ‘orig_city_name‘ VARCHAR(50),
    ‘departure_date‘ DATE,
    ‘departure_time‘ TIME,
    ‘orig_terminal‘ VARCHAR(25),
    ‘orig_gate‘ VARCHAR(25),
    ‘dest_airport‘ VARCHAR(50),
    ‘dest_city_name‘ VARCHAR(50),
    ‘arrival_date‘ DATE,
    ‘arrival_time‘ TIME,
    ‘dest_terminal‘ VARCHAR(25),
    ‘dest_gate‘ VARCHAR(25),
    ‘aircraft‘ VARCHAR(25),
    ‘service_class‘ VARCHAR(25),
    ‘distance‘ VARCHAR(25),
    ‘duration‘ VARCHAR(25),
    ‘entertainment‘ VARCHAR(25),
    ‘meal‘ VARCHAR(25),
    ‘ontime_perc‘ VARCHAR(25),
    ‘stops‘ VARCHAR(25),
    ‘seats‘ VARCHAR(25),
    ‘created_at‘ DATETIME NOT NULL,
    ‘updated_at‘ DATETIME NOT NULL,
    ‘created_by‘ INTEGER NOT NULL,
    ‘updated_by‘ INTEGER NOT NULL,
    PRIMARY KEY (‘trip_item_id‘),
    CONSTRAINT ‘air_trip_item_FK_1‘
        FOREIGN KEY (‘trip_item_id‘)
        REFERENCES ‘trip_item‘ (‘id‘)
        ON DELETE CASCADE
)Type=InnoDB;
```

The following XML schema defines the XML documents that are posted to an import application from a data map.

```
<xs:schema xmlns:xs=“http://www.w3.org/2001/XMLSchema”
targetNamespace=“http://www.tripit.com” xmlns=“http://www.tripit.com”
elementFormDefault=“qualified”>
<xs:element name=“Booking” type=“Booking”/>
<!-- Air -->
<xs:complexType name=“AirSupplierConfirmation”>
<xs:all>
  <xs:element name=“_sequence” type=“xs:integer” minOccurs=“1”/>
  <xs:element name=“confirmation_num” type=“xs:string” minOccurs=“1”/>
  <xs:element name=“airline” type=“xs:string” minOccurs=“0” maxOccurs=“1”/>
  <xs:element name=“airline_phone” type=“xs:string” minOccurs=“0” maxOccurs=“1”/>
  <xs:element name=“airline_url” type=“xs:string” minOccurs=“0” maxOccurs=“1”/>
</xs:all>
</xs:complexType>
<xs:complexType name=“AirTraveler”>
  <xs:all>
  <xs:element name=“_sequence” type=“xs:integer” minOccurs=“1”/>
  <xs:element name=“air_traveler_id” type=“xs:integer” minOccurs=“1”/>
  <xs:element name=“f_name” type=“xs:string” minOccurs=“1”/>
  <xs:element name=“m_name” type=“xs:string” minOccurs=“0” maxOccurs=“1”/>
  <xs:element name=“l_name” type=“xs:string” minOccurs=“0” maxOccurs=“1”/>
  <xs:element name=“seat_preference” type=“xs:string” minOccurs=“0” maxOccurs=“1”/>
  <xs:element name=“meal_preference” type=“xs:string” minOccurs=“0” maxOccurs=“1”/>
  </xs:all>
</xs:complexType>
<xs:complexType name=“AirETicketNumber”>
  <xs:all>
  <xs:element name=“_sequence” type=“xs:integer” minOccurs=“1”/>
  <xs:element name=“air_traveler_id” type=“xs:integer” minOccurs=“0” maxOccurs=“1”/>
  <xs:element name=“eticket_num” type=“xs:string” minOccurs=“1”/>
  </xs:all>
</xs:complexType>
<xs:complexType name=“AirFrequentFlyerNumber”>
<xs:all>
  <xs:element name=“_sequence” type=“xs:integer” minOccurs=“1”/>
  <xs:element name=“air_traveler_id” type=“xs:integer” minOccurs=“0” maxOccurs=“1”/>
  <xs:element name=“frequent_flyer_num” type=“xs:string” minOccurs=“1”/>
  <xs:element name=“airline” type=“xs:string” minOccurs=“0” maxOccurs=“1”/>
</xs:all>
</xs:complexType>
<xs:complexType name=“AirReservation”>
<xs:all>
  <xs:element name=“_sequence” type=“xs:integer” minOccurs=“1”/>
  <xs:element name=“booking_date” type=“xs:date” minOccurs=“0” maxOccurs=“1”/>
  <xs:element  name=“booking_site_conf_num” type=“xs:string” minOccurs=“0”
maxOccurs=“1”/>
  <xs:element  name=“booking_site_name” type=“xs:string” minOccurs=“0”
maxOccurs=“1”/>
  <xs:element  name=“booking_site_phone” type=“xs:string” minOccurs=“0”
maxOccurs=“1”/>
  <xs:element name=“booking_site_url” type=“xs:string” minOccurs=“0” maxOccurs=“1”/>
  <xs:element name=“fare_rules” type=“xs:string” minOccurs=“0” maxOccurs=“1”/>
  <xs:element name=“AirSupplierConfirmation” type=“AirSupplierConfirmation”/>
  <xs:element name=“AirTraveler” type=“AirTraveler”/>
  <xs:element name=“AirETicketNumber” type=“AirETicketNumber”/>
  <xs:element name=“AirFrequentFlyerNumber” type=“AirFrequentFlyerNumber”/>
  <xs:element name=“AirSegment” type=“AirSegment”/>
  </xs:all>
</xs:complexType>
<xs:complexType name=“AirSegment”>
  <xs:all>
  <xs:element name=“_sequence” type=“xs:integer” minOccurs=“1”/>
  <xs:element name=“marketing_airline” type=“xs:string” minOccurs=“0” maxOccurs=“1”/>
  <xs:element  name=“marketing_flight_number” type=“xs:string” minOccurs=“0”
maxOccurs=“1”/>
  <xs:element name=“operating_airline” type=“xs:string” minOccurs=“0” maxOccurs=“1”/>
  <xs:element  name=“operating_flight_number” type=“xs:string” minOccurs=“0”
maxOccurs=“1”/>
  <xs:element  name=“orig_airport_code” type=“AirportCode” minOccurs=“0”
maxOccurs=“1”/>
  <xs:element name=“orig_city_name” type=“xs:string” minOccurs=“0” maxOccurs=“1”/>
  <xs:element name=“departure_date” type=“xs:date” minOccurs=“0” maxOccurs=“1”/>
  <xs:element name=“departure_time” type=“xs:time” minOccurs=“0” maxOccurs=“1”/>
  <xs:element name=“orig_terminal” type=“xs:string” minOccurs=“0” maxOccurs=“1”/>
  <xs:element name=“orig_gate” type=“xs:string” minOccurs=“0” maxOccurs=“1”/>
  <xs:element  name=“dest_airport_code” type=“AirportCode” minOccurs=“0”
maxOccurs=“1”/>
  <xs:element name=“dest_city_name” type=“xs:string” minOccurs=“0” maxOccurs=“1”/>
  <xs:element name=“arrival_date” type=“xs:date” minOccurs=“0” maxOccurs=“1”/>
  <xs:element name=“arrival_time” type=“xs:time” minOccurs=“0” maxOccurs=“1”/>
  <xs:element name=“dest_terminal” type=“xs:string” minOccurs=“0” maxOccurs=“1”/>
  <xs:element name=“dest_gate” type=“xs:string” minOccurs=“0” maxOccurs=“1”/>
  <xs:element name=“aircraft” type=“xs:string” minOccurs=“0” maxOccurs=“1”/>
  <xs:element name=“service_class” type=“xs:string” minOccurs=“0” maxOccurs=“1”/>
  <xs:element name=“distance” type=“xs:string” minOccurs=“0” maxOccurs=“1”/>
  <xs:element name=“duration” type=“xs:string” minOccurs=“0” maxOccurs=“1”/>
  <xs:element name=“entertainment” type=“xs:string” minOccurs=“0” maxOccurs=“1”/>
  <xs:element name=“meal” type=“xs:string” minOccurs=“0” maxOccurs=“1”/>
  <xs:element name=“ontime_perc” type=“xs:integer” minOccurs=“0” maxOccurs=“1”/>
  <xs:element name=“stops” type=“xs:string” minOccurs=“0” maxOccurs=“1”/>
  <xs:element name=“AirSeatAssignment” type=“AirSeatAssignment”/>
  </xs:all>
</xs:complexType>
<xs:simpleType name=“AirportCode”>
  <xs:restriction base=“xs:string”>
  <xs:pattern value=“[A-Z][A-Z][A-Z]”/>
  </xs:restriction>
</xs:simpleType>
<xs:complexType name=“AirSeatAssignment”>
<xs:all>
  <xs:element name=“_sequence” type=“xs:integer” minOccurs=“1”/>
  <xs:element name=“air_traveler_id” type=“xs:integer” minOccurs=“0” maxOccurs=“1”/>
  <xs:element name=“seat” type=“xs:string” minOccurs=“1” maxOccurs=“1”/>
</xs:all>
</xs:complexType>
<!-- Hotel -->
<xs:complexType name=“Address”>
  <xs:all>
  <xs:element name=“_sequence” type=“xs:integer” minOccurs=“1”/>
  <xs:element name=“addr1” type=“xs:string” minOccurs=“0” maxOccurs=“1”/>
  <xs:element name=“addr2” type=“xs:string” minOccurs=“0” maxOccurs=“1”/>
  <xs:element name=“city” type=“xs:string” minOccurs=“0” maxOccurs=“1”/>
  <xs:element name=“state” type=“xs:string” minOccurs=“0” maxOccurs=“1”/>
  <xs:element name=“zip” type=“xs:string” minOccurs=“0” maxOccurs=“1”/>
  <xs:element name=“country” type=“xs:string” minOccurs=“0” maxOccurs=“1”/>
  </xs:all>
</xs:complexType>
<xs:complexType name=“HotelReservation”>
  <xs:all>
  <xs:element name=“_sequence” type=“xs:integer” minOccurs=“1”/>
  <xs:element  name=“supplier_confirmation_num” type=“xs:string” minOccurs=“0”
maxOccurs=“1”/>
  <xs:element name=“supplier_name” type=“xs:string” minOccurs=“0” maxOccurs=“1”/>
  <xs:element name=“supplier_phone” type=“xs:string” minOccurs=“0” maxOccurs=“1”/>
  <xs:element name=“supplier_url” type=“xs:string” minOccurs=“0” maxOccurs=“1”/>
  <xs:element name=“booking_date” type=“xs:date” minOccurs=“0” maxOccurs=“1”/>
  <xs:element  name=“booking_site_conf_num” type=“xs:string” minOccurs=“0”
maxOccurs=“1”/>
  <xs:element  name=“booking_site_name” type=“xs:string” minOccurs=“0”
maxOccurs=“1”/>
  <xs:element  name=“booking_site_phone” type=“xs:string” minOccurs=“0”
maxOccurs=“1”/>
  <xs:element name=“booking_site_url” type=“xs:string” minOccurs=“0” maxOccurs=“1”/>
  <xs:element name=“Address” type=“Address” minOccurs=“0” maxOccurs=“1”/>
  <xs:element name=“check_in_date” type=“xs:date” minOccurs=“0” maxOccurs=“1”/>
  <xs:element name=“check_in_time” type=“xs:time” minOccurs=“0” maxOccurs=“1”/>
  <xs:element name=“check_out_date” type=“xs:date” minOccurs=“0” maxOccurs=“1”/>
  <xs:element name=“check_out_time” type=“xs:time” minOccurs=“0” maxOccurs=“1”/>
  <xs:element name=“guest_name” type=“xs:string” minOccurs=“0” maxOccurs=“1”/>
  <xs:element name=“room_type” type=“xs:string” minOccurs=“0” maxOccurs=“1”/>
  <xs:element name=“avg_daily_rate” type=“xs:decimal” minOccurs=“0” maxOccurs=“1”/>
  <xs:element name=“total_cost” type=“xs:decimal” minOccurs=“0” maxOccurs=“1”/>
  <xs:element name=“currency” type=“xs:decimal” minOccurs=“0” maxOccurs=“1”/>
  <xs:element name=“number_nights” type=“xs:decimal” minOccurs=“0” maxOccurs=“1”/>
  <xs:element name=“number_guests” type=“xs:integer” minOccurs=“0” maxOccurs=“1”/>
  <xs:element name=“number_rooms” type=“xs:integer” minOccurs=“0” maxOccurs=“1”/>
  <xs:element  name=“frequent_guest_num” type=“xs:string” minOccurs=“0”
maxOccurs=“1”/>
  <xs:element  name=“cancellation_remarks” type=“xs:string” minOccurs=“0”
maxOccurs=“1”/>
  <xs:element name=“room_description” type=“xs:string” minOccurs=“0” maxOccurs=“1”/>
  </xs:all>
</xs:complexType>
<!-- Car -->
<xs:complexType name=“CarReservation”>
  <xs:all>
  <xs:element name=“_sequence” type=“xs:integer” minOccurs=“1”/>
  <xs:element  name=“supplier_confirmation_num” type=“xs:string” minOccurs=“0”
maxOccurs=“1”/>
  <xs:element name=“supplier_name” type=“xs:string” minOccurs=“0” maxOccurs=“1”/>
  <xs:element name=“supplier_phone” type=“xs:string” minOccurs=“0” maxOccurs=“1”/>
  <xs:element name=“supplier_url” type=“xs:string” minOccurs=“0” maxOccurs=“1”/>
  <xs:element name=“booking_date” type=“xs:date” minOccurs=“0” maxOccurs=“1”/>
  <xs:element  name=“booking_site_conf_num” type=“xs:string” minOccurs=“0”
maxOccurs=“1”/>
  <xs:element  name=“booking_site_name” type=“xs:string” minOccurs=“0”
maxOccurs=“1”/>
  <xs:element  name=“booking_site_phone” type=“xs:string” minOccurs=“0”
maxOccurs=“1”/>
  <xs:element name=“booking_site_url” type=“xs:string” minOccurs=“0” maxOccurs=“1”/>
  <xs:element name=“car_type” type=“xs:string” minOccurs=“0” maxOccurs=“1”/>
  <xs:element name=“car_description” type=“xs:string” minOccurs=“0” maxOccurs=“1”/>
  <xs:element  name=“pickup_location_name” type=“xs:string” minOccurs=“0”
maxOccurs=“1”/>
  <xs:element  name=“PickupLocationAddress” type=“Address” minOccurs=“0”
maxOccurs=“1”/>
  <xs:element  name=“pickup_location_phone” type=“xs:string” minOccurs=“0”
maxOccurs=“1”/>
  <xs:element  name=“pickup_location_hours” type=“xs:string” minOccurs=“0”
maxOccurs=“1”/>
  <xs:element name=“pickup_date” type=“xs:date” minOccurs=“0” maxOccurs=“1”/>
  <xs:element name=“pickup_time” type=“xs:time” minOccurs=“0” maxOccurs=“1”/>
  <xs:element  name=“dropoff_location_name” type=“xs:string” minOccurs=“0”
maxOccurs=“1”/>
  <xs:element  name=“DropoffLocationAddress” type=“Address” minOccurs=“0”
maxOccurs=“1”/>
  <xs:element  name=“dropoff_location_phone” type=“xs:string” minOccurs=“0”
maxOccurs=“1”/>
  <xs:element  name=“dropoff_location_hours” type=“xs:string” minOccurs=“0”
maxOccurs=“1”/>
  <xs:element name=“dropoff_date” type=“xs:date” minOccurs=“0” maxOccurs=“1”/>
  <xs:element name=“dropoff_time” type=“xs:time” minOccurs=“0” maxOccurs=“1”/>
  <xs:element name=“driver_name” type=“xs:string” minOccurs=“0” maxOccurs=“1”/>
  <xs:element  name=“pickup_instructions” type=“xs:string” minOccurs=“0”
maxOccurs=“1”/>
  <xs:element name=“daily_rate” type=“xs:decimal” minOccurs=“0” maxOccurs=“1”/>
  <xs:element name=“mileage_charges” type=“xs:string” minOccurs=“0” maxOccurs=“1”/>
  <xs:element  name=“frequent_renter_num” type=“xs:string” minOccurs=“0”
maxOccurs=“1”/>
  <xs:element  name=“cancellation_remarks” type=“xs:string” minOccurs=“0”
maxOccurs=“1”/>
  </xs:all>
</xs:complexType>
<xs:complexType name=“Booking”>
  <xs:all>
  <xs:element name=“_sequence” type=“xs:integer”/>
  <xs:element name=“email_from_address” type=“xs:string”/>
  <xs:element name=“email_to_address” type=“xs:string”/>
  <xs:element name=“email_subject” type=“xs:string”/>
  <xs:element name=“booking_confirm_src” type=“xs:string”/>
  <xs:element name=“booking_uuid” type=“xs:string”/>
  <xs:element name=“token” type=“xs:string”/>
  <xs:element name=“datamap_version” type=“xs:string”/>
  <xs:element  name=“AirReservation” type=“AirReservation” minOccurs=“0”
maxOccurs=“1”/>
  <xs:element  name=“HotelReservation” type=“HotelReservation” minOccurs=“0”
maxOccurs=“1”/>
  <xs:element  name=“CarReservation” type=“CarReservation” minOccurs=“0”
maxOccurs=“1”/>
  </xs:all>
</xs:complexType>
</xs:schema>
```

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
select an itinerary template based upon itinerary messages received from disparate itinerary booking events created for a single user, wherein each itinerary message characterizes a travel event;
evaluate the content of the itinerary messages to identify logical relationships between travel events based on the itinerary template;
produce enhanced travel information based on the logical relationships;
populate an itinerary form with travel events and enhanced travel information to form a comprehensive itinerary; and
deliver the comprehensive itinerary to the user.

2. The computer readable storage medium of claim 1 further comprising executable instructions to import the comprehensive itinerary in an electronic calendar of the user.

3. The computer readable storage medium of claim 1 wherein the itinerary messages are email messages.

4. The computer readable storage medium of claim 1 wherein the itinerary messages are text messages.

5. The computer readable storage medium of claim 1 wherein the travel events are selected from flight information, restaurant, hotel information, and car rental information.

6. The computer readable storage medium of claim 1 wherein the executable instructions to select include executable instructions to search a template database.

7. The computer readable storage medium of claim 6 wherein the executable instructions to select include executable instructions to search a template database in accordance with a scoring system.

8. The computer readable storage medium of claim 6 wherein the executable instructions to select include executable instructions to search a template database in accordance with historical metrics.

9. The computer readable storage medium of claim 8 wherein the executable instructions to select include executable instructions to
return multiple itinerary templates identified by said historical metrics search;
populate the multiple itinerary templates;
score the populated itinerary templates; and
select template with the highest score.

10. The computer readable storage medium of claim 1 wherein the executable instructions to produce enhanced travel information include executable instructions to generate latitude, longitude, and time coordinates associated with travel events.

11. The computer readable storage medium of claim 1 wherein the executable instructions to produce enhanced travel information include executable instructions to generate location and time dependent maps.

12. The computer readable storage medium of claim 1 wherein the executable instructions to produce enhanced travel information include executable instructions to generate location and time dependent weather information.

13. The computer readable storage medium of claim 10 wherein the executable instructions to produce enhanced travel information include executable instructions to generate information on local points of interest associated with the latitude, longitude, and time coordinates.

14. The computer readable storage medium of claim 10 wherein the executable instructions to produce enhanced travel information include executable instructions to generate information missing from the itinerary messages.

15. The computer readable storage medium of claim 1 further comprising executable instructions to generate alerts.
